(19) United States
(12) Patent Application Publication
(10) Pub. No.: US 2009/0020710 A1
(43) Pub. Date: Jan. 22, 2009

(54) SEMICONDUCTOR NANOCRYSTALS FOR TIME DOMAIN OPTICAL IMAGING

(75) Inventors: Kui Yu, Kanata (CA); Abedelnasser Abulrob, Ottawa (CA)

Correspondence Address: MARKS & CLERK, P.O. BOX 957, STATION B, OTTAWA, ON, K1P 5S7, CA

(73) Assignee: NATIONAL RESEARCH COUNCIL OF CANADA, Ottawa, ON (CA)

(21) Appl. No.: 12/279,970

(22) PCT Filed: Feb. 16, 2007
(86) PCT No.: PCT/CA07/00233

§ 371 Date: Aug. 19, 2008

Related U.S. Application Data
(60) Provisional application No. 60/774,615, filed on Feb. 21, 2006.

(51) Int. Cl. G01J 1/58; H05B 33/00; C03B 9/00

(52) U.S. Cl. 250/459.1; 250/484.4; 117/73

(57) ABSTRACT

A method of performing high repetition rate laser time domain imaging employs as fluoroprobes semiconductor nanocrystals having a fluorescence lifetime less than the laser pulse separation, typically less than 5 ns. The nanocrystals of the invention have a core/shell structure and may be surface treated to increase radiative decay. CdSe/Zns nanocrystals are particularly suitable.

### FIELD OF THE INVENTION

This invention relates to the field of optical imaging, and in particular time domain optical imaging technology that relies on high repetition rate lasers.

### BACKGROUND OF THE INVENTION

Optical imaging technology for biomedical applications involves the analysis of photon propagation through tissues. An excitation photon typically travels through tissue to reach a fluorescent contrast agent, known as a fluorophore, and is affected by the scatter, anisotropy (g), and refractive index(ices) of the tissue. The photon emitted by the fluorophore is subject to the same factors. Due to the tissue absorbance, fluorescent light is also auto-emitted by the tissue. Such high tissue auto-fluorescence precludes the use of visible light for most in vivo imaging applications. The use of near infrared (NIR) light overcomes this problem by reducing the fluorescence background and thus optimizing the signal to background ratio (SBR).

Traditional in vivo optical imaging systems measure all photons that propagate from the tissue without any temporal discrimination. The photons are detected by a cooled CCD camera system. This intensity-based technology known as the continuous wave technique cannot discriminate photon absorption from photon scattering events, neither is it capable of determining the depth and concentration of the fluoroprobe.

An alternative technique to continuous wave optical imaging is time domain optical imaging. This technology relies on the use of a high repetition laser, which interacts with tissues and emits a signal captured by a high sensitivity time-resolved photon detector.

The time domain technology relies on time-resolved single photon counting. Short pulses, typically having a pulse separation in the order of 12.ns, will excite the fluorescent probe to produce a temporal point spread function (TPSF), which can be used to determine the depth and concentration of the fluorophore as well distinguish between different fluorescent materials having a different fluorescence lifetime.

Currently, only organic fluorophores that emit in the near-infrared region, such as Cy5.5® or Alexa 700®, are used as optical imaging probes in time-domain optical imaging. The technology requires that the fluoroprobe have short fluorescence lifetime characteristics. However, conventional organic fluorophores suffer from significant limitations. Due to tissue absorption and scatter their excitation and emission wavelengths must be controlled for in vivo imaging applications. Organic fluorophores are difficult to tune to specific precise wavelengths due to the ‘inflexibility’ of their chemical structure. The tuning requires sophisticated chemistry. The emission of organic fluorophores can be adjusted only by “discrete” (rather then continuous) wavelength steps. For example, the addition of each double carbon bond will result the increase of an emission wavelength of 80-100 nm. Near-infrared organic fluorophores have a low quantum yield (less than 15%) in aqueous environments. Broad emission and narrow absorption limit use of organic fluorophores in multi-component detection (multi color detection). Conjugation chemistries for attaching organic fluorophore to a molecule of interest usually allow for one ligand per fluorophore. The detection ability for such conjugates is strongly dependent on the density of the target (e.g., antigen), i.e., it is difficult to detect low abundant targets (antigens). The susceptibility of organic fluorophores to photobleaching limits the sensitivity of detection and often precludes repeated measurements.

There is therefore a need for fluoroprobes with better characteristics for time-domain in vivo optical imaging to overcome limitations of organic fluoroprobes.

Semiconductor nanocrystals, also called quantum dots, exhibit unique optical, magnetic and electrical properties that are dependent on size and composition, both of which can be controlled during synthesis. Quantum dots have recently been proposed as an alternative to conventional organic fluorophores because they offer distinct advantages. Quantum dots have a number of useful properties. They can be tuned to any wavelength, are resistant to photobleaching, can be used for long-term monitoring, can be ‘targeted’ with multiple molecules (ligands), and can be used in multi-colour detection. Quantum dots make better imaging probes and expected to displace organic fluorophores in many applications.

Conventional organic fluorophores have emission from the first allowed singlet-singlet electronic transition in a few nanoseconds (1-5 ns), which makes them applicable in time-domain optical imaging. However, there is little knowledge about the origin of the band-gap emission of semi-conductor nanocrystals, even with a cadmium selenide (CdSe) quantum dot, which is one of the most commonly studied systems. Furthermore, there is lack of detailed studies on the photoluminescence lifetime. With different opinions expressed on the photoluminescence lifetime for a certain type of quantum dots, it seems that quantum dots have a longer photoluminescence lifetime than conventional organic fluorophores. For example, the lifetime of type I quantum dots is in the range of 30 ns (Nano Lett. 2005;5:645-8) while Type II colloidal quantum dots have longer fluorescence lifetime of around 60 ns and up to 400 ns (J Am Chem Soc. 2003; 125:11466-7). Many other studies have measured the luminescence lifetime to be around 26 ns, which is in good agreement with the radiative decay times reported for the exaction emission from CdSe QDs (J Chem Phys. 2004, 121:4310-5; J. Phys. Chem. B, 2003, 107, 489-496; Phys. Rev. Lett. 2003, 90, 257404). The change in lifetime of quantum dots was similar between CdSe quantum dots in toluene and water/lipid solution (Nano Lett. 2005;5:645-8).

The fluorescence lifetime of a molecule is the average time that the molecule resides in the excited state before photon emission occurs. When a fluorescent sample is excited using a short light pulse, many probes enter the excited state at the same instant. The probes relax at different times (t) after the excitation pulse and the fluorescence intensity, F(t), decays with time. The measurements of nanosecond lifetime are usually carried out using time or frequency domain strategy. Therefore, the contrast agent used in the time or frequency domain optical imaging with high laser repetition should have a very short fluorescence lifetime (1-5 ns).

Quantum dots have been used in traditional in vivo optical imaging, relying on cooled CCD camera to detect the near-infrared fluorescence signal (Nat Biotechnol. 2004;22:969-76). However, all quantum dots (available in the market from leading companies in the field, such as Quantum Dot Corp. (California) and Evident Technologies (New York) and NN-labs (Arkansas), have a long lifetime ranging between 20-400 nanoseconds, making them unsuitable for time-domain optical imaging applications which rely on a high repetition laser.

### SUMMARY OF THE INVENTION

The invention provides nanocrystals (quantum dots) with a short lifetime that are suitable for use in time-domain optical imaging applications and other applications that use high laser repetition protocols. The quantum dots should have a short lifetime of less than 5 ns, preferably 1-5 ns. The near-infrared (NIR) semiconductor quantum dots of the invention can be used in time-domain optical imaging with high laser repetition rates. The invention is useful, for example, as a non-invasive biomarker in animals and humans.

The luminescent colloidal semiconductor nanocrystals of the invention are designed to have an increased radiative decay rate are a result of surface modification, and accordingly, a decreased photoluminescent (PL) lifetime and increase QY). The invention permits the PL lifetime be decreased, not only via the control of the non-radiative decay rate kₙᵣ, but also via the control of the radiative decay rate π.

According to one aspect of the present invention there is provided a method of performing high repetition rate laser time domain imaging, wherein semiconductor nanocrystals having a fluorescence lifetime less than the laser pulse separation are used as fluoroprobes.

In another aspect the invention provides a method of making fluoroprobes for use in high repetition laser time domain optical imaging, comprising synthesizing CdSe core/shell nanocrystals by the sequential addition of a mixture of Zn and S precursors into CdSe nanocrystals in tri-n-octylphosphine alone or in tri-n-octylphosphine and an amine.

In yet another aspect the invention provides fluoroprobes comprising luminescent colloidal semiconductor nanocrystals with surface modification to increase the radiative decay rate.

In a still further method the invention provides a method of making fluoroprobes comprising creating nanocrystals with a core/shell structure having a surface modified to increase the radiative decay rate.

Quantum dots contain both radiative and non-radiative channels. It is believed that a synthetic approach, in which is the ligand is exchanged for water-soluble quantum dots, opens the non-radiative channels, and thus decreases lifetime. This process decreases quantum dot yield at the same time.

In one embodiment the fluoroprobes are CdSe/ZnS, but many other systems, such as CdSeS/ZnS, CdSe/ZnSe/ZnS, CdTeSe/ZnS can be employed in accordance with the invention. In general, the core-shell or layered structure should have an outermost layer with the highest band-gap energy. This is generally ZnS. It is also possible to increase the number of radiative channels to decrease lifetime. This approach is preferred, due to the possibility of the increase of the quantum yield at the same time.

Optical and near-Infrared (NIR) semiconductors nanocrystals of the invention can be used for in vivo and in vitro time-domain optical imaging with a high repetition rate laser, and particularly for imaging tissues and organs, including the brain, imaging and diagnostics, both in vivo and in vitro. The invention can also be used for radiative decay engineering of quantum dots with short PL lifetime and high quantum yield (QY).

The semi-conductor nanocrystals have short photo-luminescent (PL) lifetime, as short as less than 5 ns.

The semi-conductor nanocrystals of the invention can also be surface treated with inorganic materials and organic materials to increase the PL dynamics (namely to increase the radiative decay rate and thus to decrease PL lifetime) and to increase the population of short lifetime and decrease the population of long lifetime quantum dots.

### BRIEF DESCRIPTION OF THE DRAWINGS

This invention will now be described in more detail, by way of example only, with reference to the accompanying drawings, in which:

FIGS. 1a and 1b are graphs showing the normalized photoluminescence intensity of quantum dots against wavelength;

FIG. 2 is a graph showing the photoluminescence intensity of near IR quantum dots against wavelength;

FIG. 3a shows a schematic model of a colloidal nano-crystallite;

FIG. 3b shows the energy states of the nano-crystallite;

FIG. 3c shows a solution ¹H NMR study on surface ligands of CdSe QDs (purified and re-dispersed in THF);

FIG. 3d shows X-Ray Photoelectron Spectroscopy (XPS) study on CdS quantum dots;

FIG. 4 shows two Figures of our PL lifetime measurements, acquired with a Jobin-Yvon Horiba Fluorolog Tau-3 Lifetime System;

FIG. 5 shows the re-construction of time-domain measurement on dynamic from the data obtained from frequency-domain measurements;

FIGS. 6a to 6d show PL lifetime measurements for various emission positions, namely band-gap or deep trapping;

FIGS. 7a and 7b show experimental results on the photoluminescence dynamics of CdSe/ZnS and its corresponding quantum dots;

FIG. 8 shows the PL lifetime study with 480 nm excitation performed on one CdSe ensemble in Hex.

FIG. 9a shows photoluminescence (PL) lifetime (ns) measured of water-soluble quantum dots, with excitation wavelength of 480 nm and emission wavelength of 650 nm;

FIG. 9b shows one Figure of the presence of one addition decay channel rₐ via surface modification.

FIG. 10 shows that Photo-stability of synthesized quantum dots is superior to prior art quantum dots;

FIGS. 11a, 11b and 11c show ones animal imaging and kinetics for the quantum dots after one hour.

FIG. 12 shows the 24-hour Quantum dots imaging and kinetics;

FIG. 13 shows the histological examination of various organs of mice injected with 660 nm emission quantum dots 48-hour Quantum dots imaging and kinetics;

FIG. 14 shows the 48-hour quantum dot imaging and kinetics; and

FIG. 15a and b show the ex-vivo organ imaging at 48 h post-injections of quantum dots with an emission of 660 nm showed only some accumulation in the kidneys but cleared almost completely from the rest of the body.

### DETAILED DESCRIPTION OF THE PREFERRED EMBODIMENTS

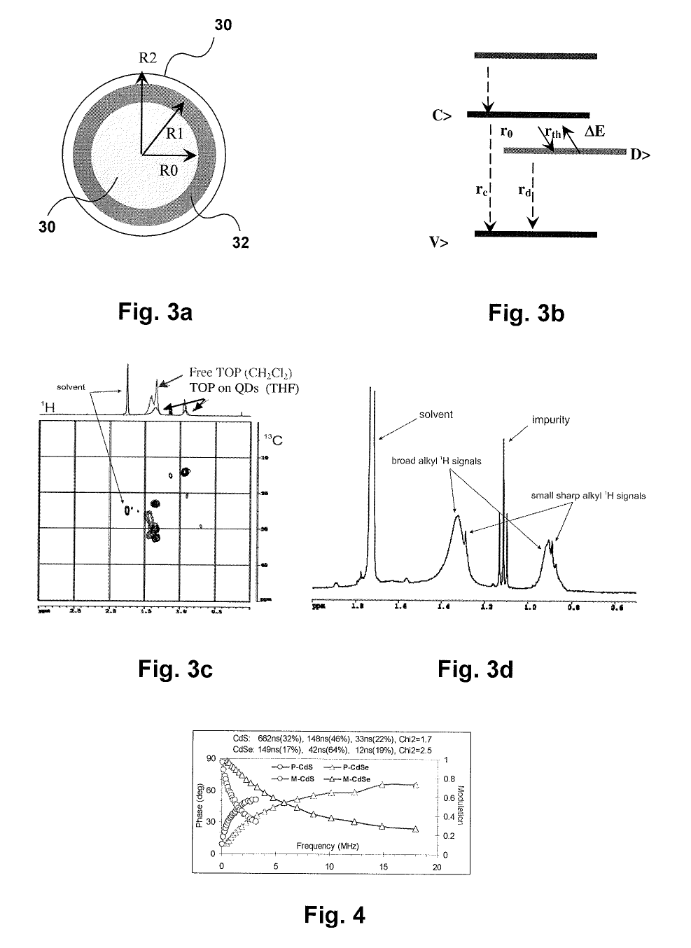

Various nanocrystallites were prepared as shown in FIG. 3a, which is a schematic model of one colloidal nano-crystallite which consists of three components, namely the capping ligand layer 30 which provides colloidal stability, the surface layer 32 between the core and the capping layer, and the core 30.

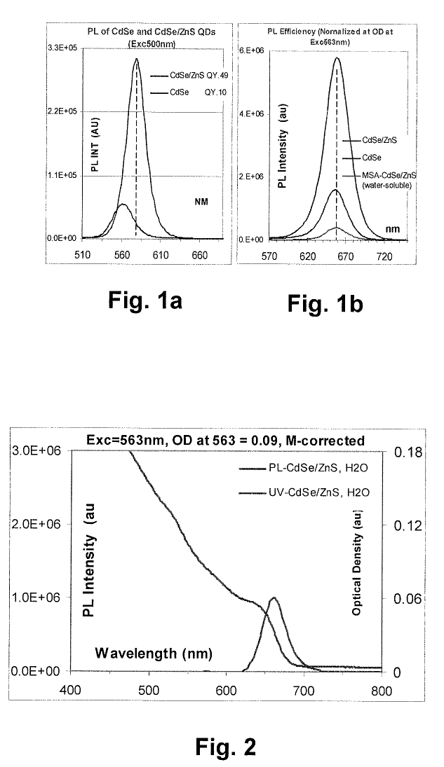

CdSe/ZnS core-shell quantum dots (QDs) were synthesized by sequential addition of a mixture of the Zn and S precursors into CdSe QDs in Tri-octylphosphine (TOP) (left) and TOP and amine (right). For the synthesis of CdSe QDs, CdO as the Cd source in the preparation of colloidal TOP-capped (left) and TOP-amine-capped (right) CdSe nano-crystals; the procedure involves nucleation at one temperature (250° C.-320° C.) followed by a period of growth at another temperature (250° C.-320° C.), without the use of any acid. Batches of CdSe nano-crystals were synthesized by which TOPSe/TOP solutions were injected into Cd-complex solutions in TOP or in a mixture of TOP and amine. The dissolution of CdO in TOP was carried out in air. It will be observed that in the synthesis of CdSe (FIG. 1a), only TOP was involved as the reaction medium; however, for CdSe (FIG. 1b), both TOP and 1-hexadecyl amine (HAD) were used, together with a multiple addition of TOPSe.

For the core-shell synthesis, ZnMe₂ and (TMS)₂S were used as the Zn and S precursors. No purification was involved prior to the addition of the shell precursor solutions in Hex/TOP. For the water-soluble QDs of Example 1, ligand exchange was performed in MeOH.

FIGS. 1a and 1b show the successful engineering of QDs with improved photoluminescence (PL) efficiency via ZnS surface coating. The specific conditions for the example shown in FIG. 1a were:

A swift injection of the TOPSe/TOP solution (at room temperature) was carried out into a hot solution of CdO in TOP at 300° C., followed by a period of growth (5-10 min) at a lower temperature (250° C.).

Afterwards, the temperature of the CdSe solution was lowered to 150° C., followed by a slow injection of a mixture of Zn(Me)2 (0.408 mL) and bis(trimethylsilyl) sulfide [(TMS)2S] (0.0855 mL) in TOP (0.358 g), for the synthesis of CdSe/ZnS. The ZnS shell was grown at 200° C.

The TOPSe/TOP solution was made by sonication with 0.225 g TOP (Aldrich, 90%) and 0.008 g Se (300 mesh, Alpha Products).

The CdO-TOP solution was made by dissolving CdO 0.02583 g in 1.314 g TOP (loaded in a reaction flask) in air with increase in temperature.

For FIG. 1(b), the conditions were:

A swift injection of the TOPSe/TOP solution (at room temperature) was carried out into a hot solution of CdO in HDA/TOP at 320° C., followed by a period of growth (5-10 min) at 320° C. Also, another slow injection of the TOPSe/TOP solution (at room temperature) into the CdSe solution was performed to grow the dots to emit at ca. 650 nm.

Afterwards, the temperature of the CdSe solution was lowered to 150° C., followed by a slow injection of a mixture of Zn(Me)2 (0.2 mL) and bis(trimethylsilyl) sulfide [(TMS)2S] (0.04 mL) in TOP (0.15 g), for the synthesis of CdSe/ZnS. ZnS shell was grown at 200° C. was involved.

The TOPSe/TOP solution was made by sonication with 0.268 g TOP (Aldrich, 90%) and 0.004 g Se (300 mesh, Alpha Products). Two such solutions were made.

The CdO-HAD/TOP solution was made by dissolving CdO 0.02 g in 0.56 g TOP and HDA (loaded in a reaction flask) in air with increase in temperature. It was 75% HAD (1.48 g).

It will be appreciated by one skilled in the art that there are many systems other than CdSe/ZnS, such as CdSeS/ZnS, CdSe/ZnSe/ZnS, CdTeSe/ZnS that may be suitable. In general, the material with the highest band-gap energy should be used for the outermost layer, which is ZnS.

The synthesis of binary or ternary or layered or core-shell dots, which involves S, (TMS)2S can be replaced by elementary sulfur; namely, elementary S can also be used together with traditional accelerators used in rubber vulcanization, such as 2,2′-dithiobisbenzothiazole.

Optical absorbance spectra were collected using a Perkin Elmer Lambda 45 UV-Vis spectrometer and a 1 nm data collection interval. Steady-state photo-luminescence experiments were performed with a Jobin Yvon Horiba Fluoromax3 spectrometer with data sampling interval of 2 nm. This ensemble of water-soluble CdSe/ZnS dots were obtained with a ligand reaction. Bi-functional compounds, such as mercaptosuccinic acid (MSA) and mercaptoundecanoic acid (MUA), were used to transfer the dots shown in FIG. 1b into water. FIG. 2 shows the successful engineering of water-soluble near-IR QD (with short lifetime).

FIGS. 3a and 3b show the possible origin of emission. The dynamics of the photo-luminescence of semi-conductor nanocrystals is a complicated issue, with different opinions expressed, even, on the origin of the emission. However, a three-state model is often used to explain the relaxation process, which may involve core-state and surface-state emissions. As shown in FIG. 3b (right), V> represents a ground state in the valance band. In the core-related emission, C> represents an optically active state in the conduction band, with a total spin projection on the crystal hexagonal axis J=+/−1.

Meanwhile, D> represents an optically inactive (forbidden) state, with J=+/−2 and with a lower energy (ΔE) of 1-15 meV. Usually, the spin flip rate rₒ is larger than the recombination rate r_{c} from C> to V>, and r_{c} is larger than the recombination rate rd from D> to V>. The photo-luminescent lifetime T from CdSe/ZnS QDs in PMMA polymer was reported to be 1 μs at 3K (dark exciton) and ca. 10 ns at 140K (bright exciton).

In surface-related emission, it has been accepted that an incoming photon can create one electron-hole pair, namely one exciton, and the charge carriers move to the surface quickly and get trapped. Due to the fact that electrons have a much smaller effective mass than holes, and are thus more mobile, electron traps are often the adoption of the convention. Thus, C> represents a delocalized surface state and D> a localized surface state. Depending on the value of ΔE, such trapping can shallow (ΔE˜meV) or deep (ΔE˜1000 meV). A shallow trap gives band-gap emission, while a deep trap gives deep-trap emission. A shallow trap electron can thermally de-trap from D> to C>, and recombine with a hole in V> with a photon emitted out. On the other hand, a localized trapped electron couples to the lattice vibrations; before it can recombine with a hole in V>, it must wait for a favorable nuclear configuration 9 in the Frank-Condon sense). Therefore, r_{c} is larger than r_{d}.

At room temperature, for CdSe dots capped in PMMA films, photo-luminescence is originated from both core and surface, with τ₁ of 2-5 ns (core-related) and τ₂ of 15-25 ns (surface-related). Various studies have been reported on the photo-luminescence properties of such systems in the literature.

For example, for colloidal QDs, investigation has been carried on their photo-luminescent dynamics, with, usually, PL τ>10 ns reported: CdSe—CHCl3, τ30-90 ns (06 Analy Chem); Qdot-CdSe/ZnS, 10 ns; CdSe-Toluene and Hexanex, 26 ns (Nerthlands); CdSe-Toluene, 30 ns (Nerthlands); CdSe/ZnS-Tol, 20 ns; CdSe/CdS-Tol, 30 ns, while in H2O, 30 ns (Sandia). It was also reported that for τ, PbS>PbSe with 1 μs vs 880 ns. Also, CdTe-thiol: band-gap 510 nm emission with T of 20 ns and deep trap 640 nm emission with T of 120 ns; CdTe—CHCl3, 10 ns, and in H2O 20 ns; CdTe-Tol and Hex, 18 ns (local-field study); CdTe—CHCl3, 16.7 ns (Min Xiao)

For colloidal CdSe (in toluene) with PL τ<5 ns, M. A. El-Sayed reported two radiative decays with τ₁ 1-5 ns and τ₂ 25-35 ns in 2001; such multiple emission pathways were related to two distinct traps. In the same year, he reported in another publication about PL T of colloidal CdSe (in toluene), but with a three exponential fitting to the decay curve, giving 3 ns, 12 ns, and 45 ns, without any further information provided.

The above PL τ studies were performed with time-domain measurements, where a short pulse of light is used to excite the QDs and the subsequent QD photo-luminescent intensity is then measured as a function of time. In addition to the time domain, photo-luminescent lifetime can also be measured in the frequency domain. Frequency-domain measurements, where the sample is illuminated with a sinusoidally modulated continuous-wave laser and its fluorescence lifetime is determined from the phase change and modulation have been reported. M. A. Hines and P. Guyot-Sionnest in 1996 reported, without specifying whether the characterization was on band-gap emission or on both the band-gap and deep-trapping emissions, that: CdSe in CHCl₃ gave 290 ns (59.5%), 49 ns (29%), 6.1 ns (10%), and 0.7 ns (1.5%), while CdSe/ZnS in CHCl₃ 160 ns (8.5%), 26 ns (53%), 12 ns (37%0, and 1.5 ns (1.5%).

In another study, J. R. Lakowicz (1999) reported that CdS with emission at ca. 500 nm (and large size distribution as indicated by the large FWHM (>100 nm)) in MeOH gave 3.1 ns (75%), 50.2 ns (16%), and 170 ns (9%), with χ2=1.1; while CdS with emission at 650 nm (deep trapping) in MeOH gave 150 ns (75%), 1171 ns (24%), and 25320 ns (8%), with χ2=2.7.

Turning now to FIG. 3c, this shows a solution ¹H NMR study on surface ligands of CdSe QDs (purified and re-dispersed in THF). Such a NMR study provides direct evidence on the presence of surface ligands.

FIG. 3d shows an X-Ray Photoelectron Spectroscopy (XPS) study on CdS quantum dots. Such a XPS stud, namely the binding energy fitting of S2p_{3/2} and S2p_{1/2} spin-orbit split doublets as well as Cd3d_{5/2} and Cd3d_{3/2} spin-orbit split doublets, provides the evidence on the existence of the core and surface species of both Cd and S.

FIG. 4 shows two examples of PL lifetime measurements performed on quantum dots in accordance with embodiments of the invention and acquired with a Jobin-Yvon Horiba Fluorolog Tau-3 Lifetime System (frequency-domain), which is the most advanced spectro-fluorometers ever made by Horiba. The two samples were CdS (spherical symbols) and CdSe (triangular symbols) quantum dots in Hex, and the signals were obtained from their band-gap emission position with a band pass of 14 nm. It will be observed that the band-gap emission of the CdSe examples has a faster radiative decay than that of CdS. The underlying reasons may be related to the difference in bonding energy (Cd—S>Cd—Se) and in dielectric screening. According to the data fitting, the CdSe QDs in Hex Example three radiative decay channels. FIG. 4 shows the 3 radiative decay channels detected for CdS and CdSe colloidal QDs.

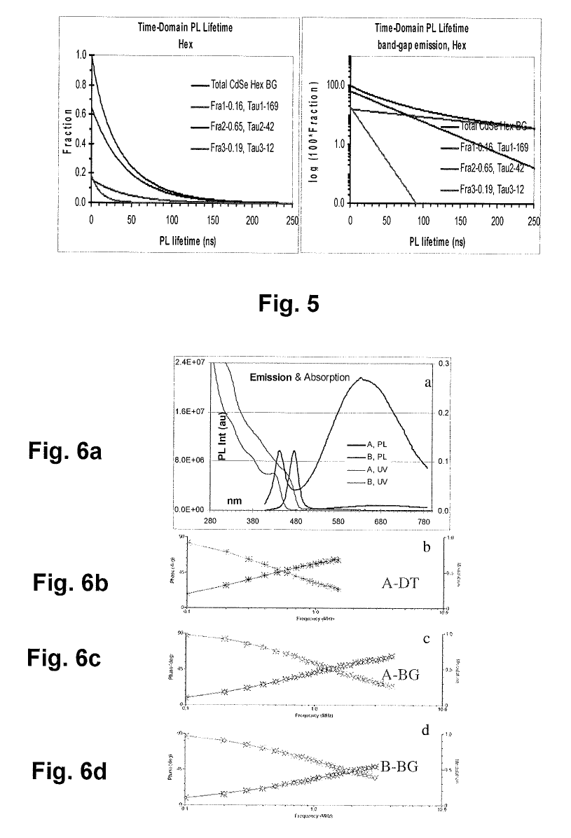

FIG. 5 shows time-resolved PL decay constructed from the lifetime data and population data of the CdSe QDs in Hex, obtained by our frequency-domain instrument shown in FIG. 4. With the linear-scale (left) and logarithmic-scale (right) presentation, the blue PL decay curve has a tri-exponential form of

A₁ exp (−t/τ₁)+A₂ exp (−t/τ₂)+A₃ exp (−t/τ₃)

where Aᵢ and τᵢ (i=1, 2, and 3) representing the population (fraction) and its corresponding radiative decay time (PL lifetime). The blue decay curve, thus, consists of 3 decay curves (left) or lines (right) of the three lifetime components.

FIG. 5 shows the re-construction of time-domain measurement on dynamic from the data obtained from frequency-domain measurements.)

FIG. 6 shows the importance of the specification of the emission position measured, during PL lifetime investigation, namely band-gap or deep trapping. The absorption (UV, thin) and emission spectra (PL, thick) of the two QDs (labeled as A and B) in hexane are presented in 6a, with the right axis of emission and left axis of absorption. The absorption spectra are normalized at the exciton absorption and the emission spectra at the band-gap (BG) emission position. The two QDs Example both band-gap (BG) emission and deep-trap (DT) emission. The PL lifetime study performed on the deep-trap emission and band-gap emission of Sample A is shown in FIGS. 6b and 6c, while that on the band-gap emission of Sample B in FIG. 6d. The PL lifetime (Tau) and the corresponding population (Fra) are summarized in Table 1.

| | | | | | |
|---|---|---|---|---|---|
| Fra1 | 0.37 | 1027 | ns | Tau1 | A-DT |
| Fra2 | 0.52 | 341 | ns | Tau2 | |
| Fra3 | 0.12 | 74 | ns | Tau3 | |
| Fra1 | 0.34 | 510 | ns | Tau1 | B-BG |
| Fra2 | 0.50 | 152 | ns | Tau2 | |
| Fra3 | 0.16 | 34 | ns | Tau3 | |
| Fra1 | 0.28 | 669 | ns | Tau1 | B-BG |
| Fra2 | 0.46 | 140 | ns | Tau2 | |
| Fra3 | 0.26 | 30 | ns | Tau3 | |

Table 1 shows the PL lifetime (Tau) and the corresponding population (Fra) obtained from the measurements mentioned in FIG. 5. It is clearly seen that the deep-trapping emission example has much slower decay rates than that of the band-gap emission. Also, samples A and B have similar decay rates.

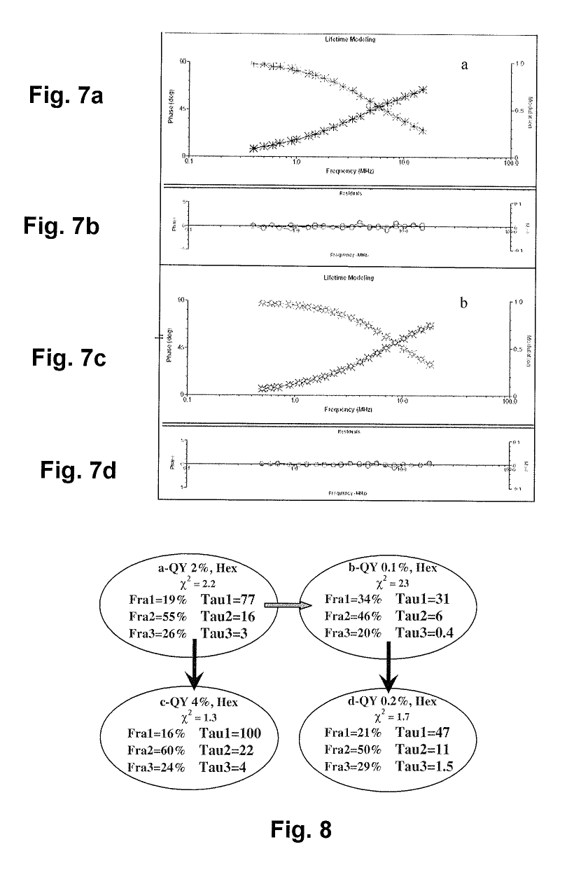

FIG. 7 shows surface post-treatment is able to decrease the population with the slowest decay of the band-gap emission in one CdSe ensemble. With 480 nm excitation, the PL lifetime detection of CdSe in Hex (562 nm, band-gap emission) and CdSe/ZnS in Hex (578 nm, band-gap emission, the core-shell is synthesized via sequential addition of the shell precursor) are shown in FIGS. 7a and 7b, respectively. The steady-state emission is shown in FIG. 1 (left).
CdSe: QY 10%, Hex, χ²=0.336
Fra1=16% Tau1=169
Fra2=65% Tau2=42
Fra3=19% Tau3=12
CdSe/ZnS: QY 49%, Hex, χ²=0.305
Fra1=8% Tau1=170
   Fra2=58% Tau2=31
   Fra3=34% Tau3=15

FIG. 7 shows the experimental results on the PL dynamics of CdSe and its corresponding CdSe/ZnS QDs.

FIG. 8 shows the PL lifetime study with 480 nm excitation performed on one CdSe ensemble in Hex. From a to b, the surface ligands are washed for the purpose of lowering quantum yield (QY); from a to c or b to d, the QDs are stored in dark after a few days to increase QY. It is clearly that the middle-lifetime component increases when QY increase.

The nature of the shortest-lifetime component may be related to both core-state and surface-state emissions, while the nature of the middle-lifetime component and the longest-lifetime component can be attributed to the surface-state radiative recombination of carriers. The supportive experimental data are shown in FIG. 8.

Photo-luminescent lifetime engineering is possible, due to the fact that the 3 decay channels are surface-related: a certain choice of surface ligands (from the synthesis of colloidal semi-conductor nano-crystals) as well as the post-treatments, namely surface treatments can fasten the decay dynamics. From principle, when the electron from the conduction band is shuttled to the valence band of one excited semi-conductor nano-crystal, the radiative decay dynamics is fastened. Chemical compounds such as electron acceptor can behave as electron shuttles.

For traditional dye molecules, radiative decay is relatively fixed as compared to non-radiative decay which is affected more by environments. Colloidal semi-conductor nano-crystals are a class of intermediates between single molecules and bulk solid-state materials; due to high surface-to-volume ratios, the surface of the semi-conductor nano-crystals, including surface ligands, plays an important role in their properties, including photo-luminescent lifetime.

FIGS. 7 and 8 show that the 3 radiative decay channels are surface-related.

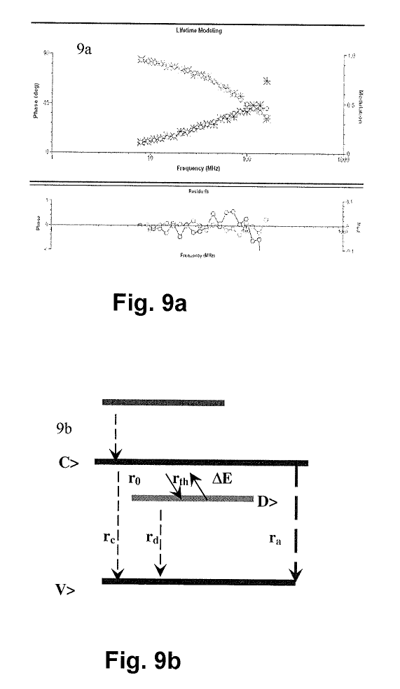

FIG. 9a shows photoluminescence (PL) lifetime (ns) measured of water-soluble quantum dots, with excitation wavelength of 480 nm and emission wavelength of 650 nm.

It should be noted that in water (resembling biological systems) the quantum dots have a lifetime of less than 5 ns for more than 85% of the population.
χ2=1.31
18.9 ns (14%)
2.6 ns (66%)
0.1 ns (20%)

FIG. 9a shows the short lifetime of our water-soluble QDs; such an ability to modify the PL lifetime can have profound implications for technology applications.

In general, quantum yields (QY₀) and photo-luminescence lifetimes (τₒ) are governed by the magnitudes of the radiative decay rate π and the sum of the nonradiative decay rates (kₙᵣ), as shown below

QY₀=(π)/(π+kₙᵣ)

τₒ=(π+kₙᵣ)⁻¹

Usually, emitters with high radiative rates have high quantum yields and short lifetimes. The lifetime of one emitter is determined by the sum of the rates which depopulation the excited state, and it can be increased or decreased by change the value of kₙᵣ. Almost invariably, the lifetimes and quantum yields increase or decrease together. FIG. 9b shows the presence of one addition radiative decay rate, πₐ. Thus,

QY=(π+πₐ)/(π+πₐ+kₙᵣ)

τ=(π+πₐ+kₙᵣ)⁻¹

Example 9b shows one example of the presence of one addition decay channel rₐ via surface modification. There are different approaches to create this addition channel rₐ. If surface ligands shuttle the electron from the conduction band to the valence band of the excited QD, photo-luminescent dynamics can be fasten. Usually, chemicals, with redox potential larger than that of the conduction band of the QDs, can be considered to fasten the PL dynamics. Also, the presence of a metal surface at a certain distance can help.

FIG. 9b shows the presence of addition decay channels with faster decay rates than the existing ones is the approach of the radiative decay engineering of semi-conductor nanocrystals, particularly for the purpose of QDs with short PL lifetime but high PL efficiency (QY).

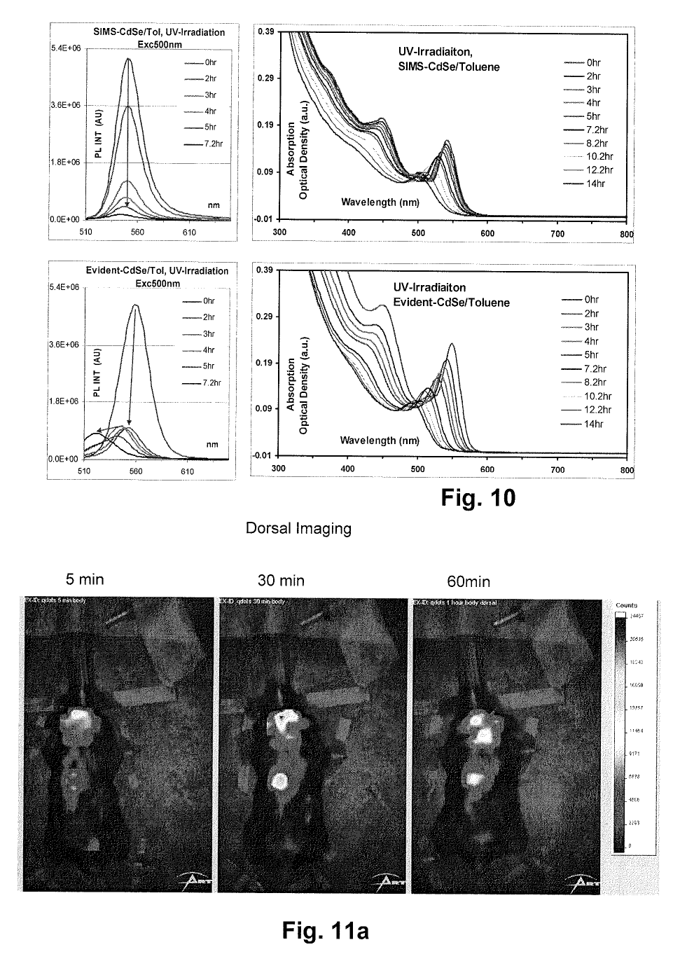

FIG. 10 shows that Photo-stability of synthesized quantum dots is superior to marketed ones (Example: Quantum dots from Evident technologies company)

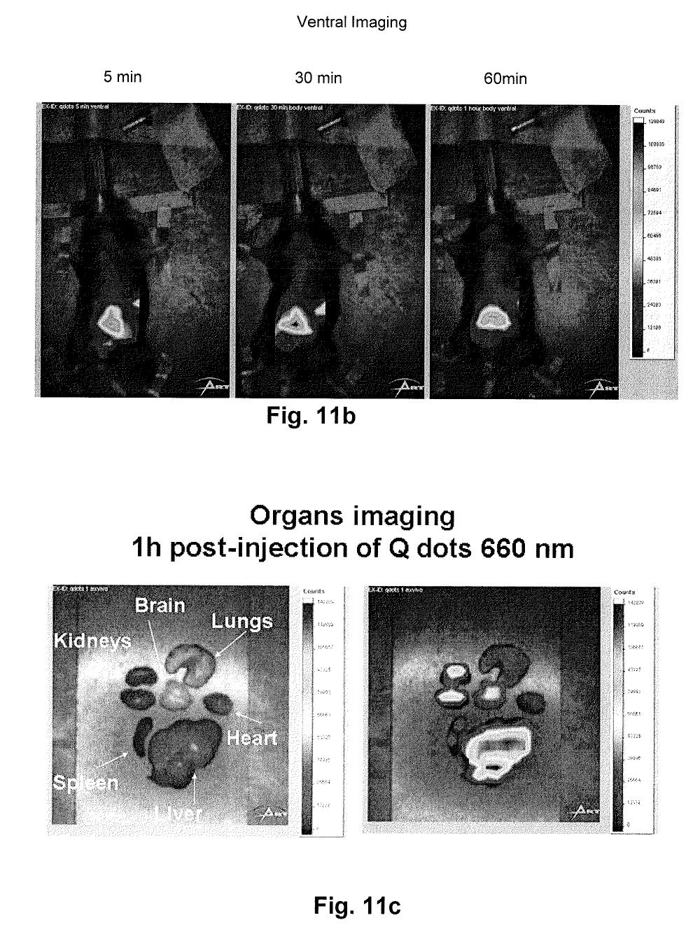

In one animal imaging and kinetics study (FIGS. 11a to 11c), female B57 mice were used for experiments in these studies. The mice were 6-8 weeks and weighed 20-30 g at the time of these studies. All experiments were carried out in compliance with the guide for the animal and care committee. In vivo imaging was performed on an eXplore Optix molecular imager (GE healthcare) with a pulsed laser diode emitting at 670 nm, 80 MHz repetition rate, pulse length <100 ps. After anesthesia by isofluorane, quantum dots were administered via a tail vein injection (0.2 ml) using a 0.5-ml insulin syringe with a 27-gauge fixed needle. Immediately postinjection, the animal was positioned supine on a plate that was then placed on a heated base (36° C.) in the imaging system. A two-dimensional scanning region encompassing the whole body was selected via a top-reviewing digital camera. The optimal elevation of the animal was verified via a side-viewing digital camera. The animal was automatically moved into the imaging chamber for scanning. Laser power and counting time per pixel were optimized at 170 μW and 0.3 s, respectively. These values remained constant during the entire experiment. Data analysis was determined by using time domain software (ART advanced Research Technologies, Saint-Laurent, Quebec).

This study demonstrates visualization of quantum dots (near infrared emission) injected intravenously in mice and followed for short period of time up to 60 min. The strongest signal was in the ventral position related to the liver due to the fast uptake of the non-PEGylated quantum dots by the hepatic reticuloendothelial system. Ex vivo imaging of organs after perfusion (which will clear the circulation from the quantum dots) indicates the highest signal is in the liver and kidneys.

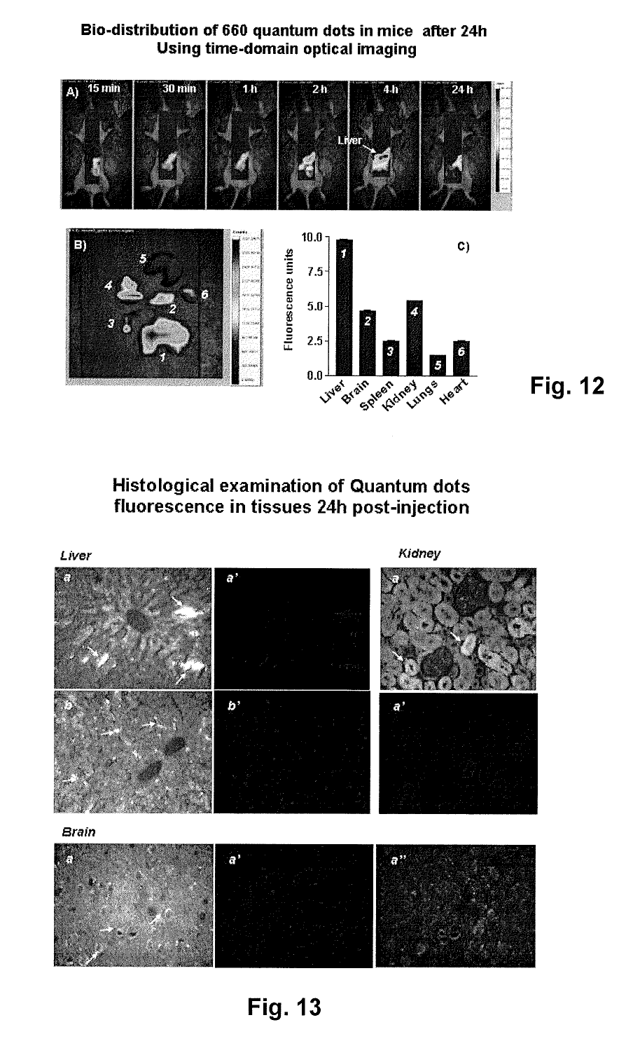

In another imaging and kinetics study (FIG. 12), female CD-1 mice were used for experiments in these studies. The mice were 6-8 weeks and weighed 20-30 g at the time of these studies. All experiments were carried out in compliance with the guide for the animal and care committee. In vivo imaging was performed on an eXplore Optix molecular imager (GE healthcare) with a pulsed laser diode emitting at 670 nm, 80 MHz repetition rate, pulse length <100 ps. After anesthesia by isofluorane, quantum dots were administered via a tail vein injection (0.2 ml) using a 0.5-ml insulin syringe with a 27-gauge fixed needle. Immediately postinjection, the animal was positioned supine on a plate that was then placed on a heated base (36° C.) in the imaging system. A two-dimensional scanning region encompassing the whole body was selected via a top-reviewing digital camera. The optimal elevation of the animal was verified via a side-viewing digital camera. The animal was automatically moved into the imaging chamber for scanning. Laser power and counting time per pixel were optimized at 30 μW and 0.3 s, respectively. These values remained constant during the entire experiment. Data analysis was determined by using TD software (ART advanced Research Technologies, Saint-Laurent, Quebec).

This study shows the biodistribution of 660 nm emitter quantum dots in mice by time-domain optical imaging. A) mice were injected intravenously (tail vein) with 200 □l of 660 nm quantum dots emitters (10 pmol) dissolved in saline and sonicated. Animals were anaesthetized with isoflurane and imaged repeatedly at indicated time points on their ventral side using a time-domain in vivo optical imaging system for small animals (eXplore Optix®). Notice the accumulation of the quantum dots mainly in the liver region B) Ex-vivo organ imaging 24 h after injection of 660 nm quantum dots (after the last whole-body imaging), mice were perfused with saline, organs were dissected and imaged ex vivo. Relative fluorescence of each organ was quantified and shown in (c). Each bar in C is mean +/− SD of three separate determinations.

In yet another study (FIG. 13) the histological examination of various organs of mice injected with 660 nm emission quantum dots. Mice were injected intravenously (tail vein) with 200 pl of 660 nm quantum dots (10 pmol) dissolved in saline and sonicated. After in vivo optical imaging, animals were perfused with saline, organs were dissected, sectioned on cryostat and examined simultaneously under light (a) and fluorescence (a′) microscope to detect 660 nm Quantum dots (emission 710/50 nm filter). Quantum dots were detected in liver sinusoids (arrows), kidney tubules (arrows) and attached to the walls of brain vessels (arrows). To confirm intravascular localization of 660 nm quantum dots, brain vessels were stained with the lectin, GSL-1 (green) (a″). Gross histological examinations in different organs (liver, kidneys, lungs and brain) indicate no obvious necrosis or toxicity in response to 24 hours post injection of quantum dots.

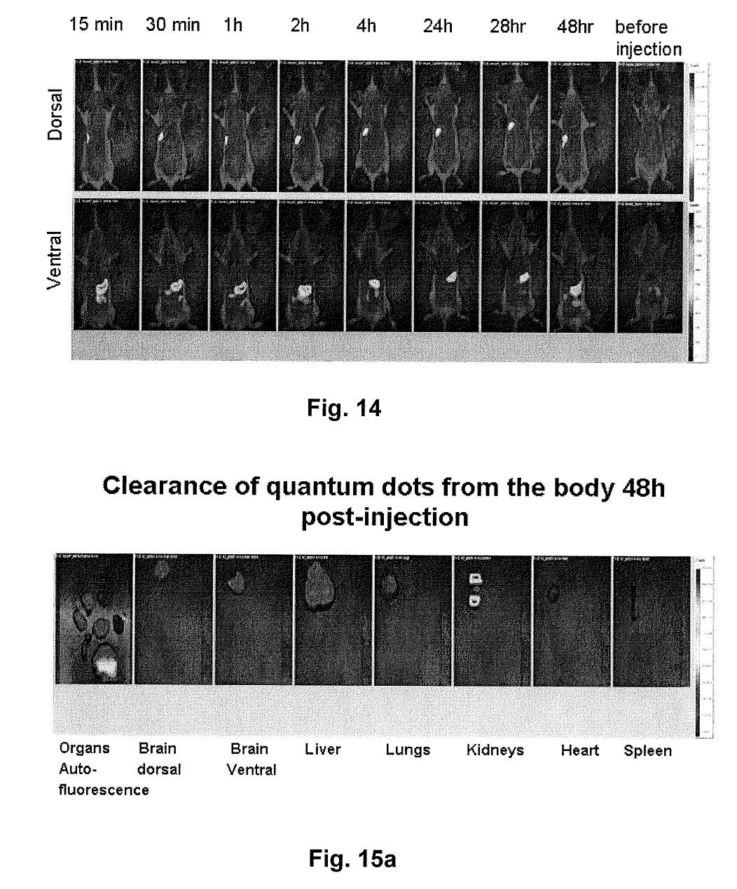

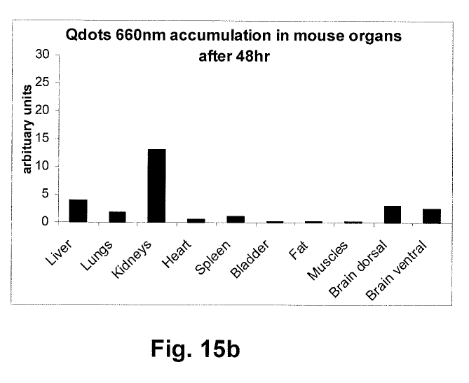

In a 48-hour Quantum dots imaging and kinetics study (FIG. 14), female CD-1 mice were used for experiments in these studies. The mice were 6-8 weeks and weighed 20-30 g at the time of these studies. All experiments were carried out in compliance with the guide for the animal and care committee. In vivo imaging was performed on an eXplore Optix molecular imager (GE healthcare) with a pulsed laser diode emitting at 670 nm, 80 MHz repetition rate, pulse length <100 ps. After anesthesia by isofluorane, quantum dots were administered via a tail vein injection (0.2 ml) using a 0.5-ml insulin syringe with a 27-gauge fixed needle. Immediately postinjection, the animal was positioned supine on a plate that was then placed on a heated base (36° C.) in the imaging system. A two-dimensional scanning region encompassing the whole body was selected via a top-reviewing digital camera. The optimal elevation of the animal was verified via a side-viewing digital camera. The animal was automatically moved into the imaging chamber for scanning. Laser power and counting time per pixel were optimized at 30 μW and 0.3 s, respectively. These values remained constant during the entire experiment. Data analysis was determined by using TD software (ART advanced Research Technologies, Saint-Laurent, Quebec).

This Example shows biodistribution of 660 nm emitting quantum dots in mice up to 48 hours by optical imaging. A) mice were injected intravenously (tail vein) with 200 μl of 660 nm quantum dots (10 pmol) dissolved in saline and sonicated. Animals were anaesthetized with isoflurane and imaged repeatedly at indicated time points using a time-domain in vivo optical imaging system for small animals (eXplore Optix®). Notice the significant signal in animals injected with the quantum dots compared to animals before injection. Moreover notice that most of the quantum dots are cleared from the body due to the rapid uptake by the reticuloendothelial system. PEGylation of the functionalized quantum dots expected to have a longer residence time in the body.

This Example shows ex-vivo organ imaging at 48 h post-injections of quantum dots with an emission of 660 nm showed only some accumulation in the kidneys but cleared almost completely from the rest of the body. This makes the quantum dots ideal for optical molecular imaging because of the low background.

Water soluble NIR semiconductor quantum dots were synthesized that have short lifetime (as shown in FIGS. 1 and 2). For example, the synthesized CdSe/ZnS QDs exhibit 660 nm emitting and were about 7 nanometers in diameter. The preliminary photoluminescence lifetime characterization shows that eighty percent of the quantum dots population had a lifetime of less than 3.4 ns measured by Frequency domain technology.

The synthesized quantum dots are useful for in vivo and near infrared imaging and enable new and novel applications in biology, drug discovery and development as well as clinical diagnosis. They can form targeted molecular probes when conjugated to antibodies, proteins or oligonucleatides.

These quantum dots are successfully used with the instrument (eXplore Optix, distributed by General Electrics) that uses high laser repetition for time-domain in vivo optical imaging as shown in FIGS. 4 to 8.

The successful usage of the quantum dots synthesized in accordance with the invention in the GE instrument suggests that the novel method which engineers the growth of the core and the shell may play an important role in photoluminescence lifetime. One way of growing of the CdSe core is described in more detail in our U.S. patent application Ser. No. 11/024,823, filed Dec. 30, 2004; and Langmuir 2004,20:11161-8; J Nanosci Nanotechnol. 2005, 5:659-668, the contents of which are herein incorporated by reference. The experimental data shows that such a CdSe core is much more photo-stable than commercially available cores. The surface ligands used for water soluble quantum dots are tri-n-octylphosphine (TOP) and mercatosuccinic acid (MSA). Such a coating provides a flexible carboxylate surface to bio-conjugate many biological moieties such as antibodies, proteins or oligonucleotides. Studies carried out to date suggest no acute toxicity of the quantum dots.

1. A method of performing high repetition rate laser time domain imaging, wherein semiconductor nanocrystals having a fluorescence lifetime less than the laser pulse separation are used as fluoroprobes.

2. A method as claimed in claim 1, wherein said fluorescence lifetime of said semiconductor nanocrystals is less than about 5 ns.

3. A method as claimed in claim 1, wherein said semiconductor nanocrystals have a core/shell structure.

4. A method as claimed in claim 1, wherein said semiconductor nanocrystals comprise a CdSe core and a ZnS shell.

5. A method as claimed in claim 1, wherein said semiconductor nanocrystals are water soluble.

6. A method as claimed in claim 1, wherein said semiconductor nanocrystals have surface ligands.

7. A method as claimed in claim 1, wherein said semiconductor nanocrystals are surface treated to decrease their fluorescence lifetime.

8. A method as claimed in claim 1, wherein the semiconductor nanocrystals are grown in the absence of an acid.

9. A method as claimed in claim 4, wherein the semiconductor nanocrystals are synthesized by the sequentional addition of Zn and S precursors into CdSe quantum dots in tri-n-octylphosphine.

10. A method as claimed in claim 4, wherein the semiconductor nanocrystals are synthesized by the sequent ional addition of Zn and S precursors into CdSe nanocrystals in tri-n-octylphosphine and an amine in the absence of an acid.

11. A method of making fluoroprobes for use in high repetition laser time domain optical imaging, comprising synthesizing CdSe core/shell nanocrystals by a procedure selected from the group consisting of: the sequential addition of a mixture of Zn and S precursors into CdSe quantum dots in tri-n-octylphosphine alone and the sequential addition of a mixture of Zn and S precursors into CdSe nanocrystals in tri-n-octylphosphine and an amine.

12. (canceled)

13. A method as claimed in claim 11, wherein the CdSe cores are synthesized from CdO.

14. A method as claimed in claim 11, wherein the CdSe cores are synthesized by nucleation at a first temperature followed be a period of growth at a second temperature without the use of an acid.

15. A method as claimed in claim 14, wherein the first and second temperatures both lie in the range 250-320° C.

16. Semiconductor nanocrystals having a fluorescence lifetime less than 5 ns.

17. Semiconductor nanocrystals as claimed in claim 16, having a core/shell structure.

18. Semiconductor nanocrystals as claimed in claim 16, which are water soluble.

19. Semiconductor nanocrystals as claimed in claim 16, wherein comprising a CdSe core and a ZnS shell.

20. (canceled)

21. (canceled)

22. Fluoroprobes comprising luminescent colloidal semiconductor nanocrystals with surface modification to increase the radiative decay rate.

23. Fluoroprobes as claimed in claim 22, which have a core/shell structure.

24. Fluoroprobes as claimed in claim 23, which have a CdSe/ZnS core/shell structure.

25. Fluoroprobes as claimed in claim 23, which have a CdSeS/ZnS, CdSe/ZnSe/ZnS, or CdTeSe/ZnS core/shell structure.

26. (canceled)
